(19) United States
(12) Patent Application Publication
(10) Pub. No.: US 2009/0260562 A1
(43) Pub. Date: Oct. 22, 2009

(54) Retractable Parking and Safety Cone and Method of Use

(75) Inventors: John Folstad, Waukegan, IL (US); Lee E. Pogue, Kenosha, WI (US); Tony Hood, Libertyville, IL (US)

Correspondence Address: NEAL, GERBER, & EISENBERG, SUITE 1700, 2 NORTH LASALLE STREET, CHICAGO, IL, 60602, US

(73) Assignee: JLT Global Enterprises, Libertyville, IL (US)

(21) Appl. No.: 12/105,089

(22) Filed: Apr. 17, 2008

(51) Int. Cl. B60Q 1/48

(52) U.S. Cl. 116/28 R

(57) ABSTRACT

The present invention includes a retractable signaling apparatus and a method of using the apparatus to alert passers-by to the presence of a stationed vehicle that may be obscured from view. In situations that include the parking of a small vehicle or the stationing of such a vehicle along a road due to mechanical difficulties, it is often difficult for passers-by, including pedestrians and other motorists, to be aware of the presence of the vehicle. In such situations the present invention provides an easily carried signaling device that can be tethered to the vehicle. The signaling device provides an alert to passers-by of the presence of the vehicle in a timely manner such that collision with the vehicle can be avoided. The tethering means ensures that the alert is maintained in view of ambient conditions or mischief that could otherwise cause the loss of the alerting device.

### FIELD OF THE INVENTION

The present invention relates to traffic and safety devices for use with motorcycles and other vehicles and objects. More particularly, the present invention relates to warning devices that can be carried on a motorcycle, or other vehicle, and when set up in accordance with the teachings of the present invention will warn passersby of the presence of a parked vehicle or other stationary object obscured by adjacent parked vehicles or other objects.

### BACKGROUND OF THE INVENTION

All too often, parked motorcycles (and other small vehicles including bicycles) are damaged in parking spaces due to accidents with other vehicles. These accidents occur because motorcycles can be obscured by the presence of larger vehicles parked in adjacent parking spaces making the motorcycle's parking space appear to be empty to oncoming traffic. An oncoming driver may think that the space is empty and try to pull into the space occupied by the motorcycle or other small vehicle and before there is enough time to react, collide with the vehicle causing damage to both vehicles. In the past, motorcycle drivers have made attempts to protect their vehicle, by, for example, parking them further out from the curb such that passers-by can more readily see the vehicle; however, parking back from the curb can lead to other problems resulting from the vehicle being parked too close to moving traffic.

Previous attempts to provide any type of viewable device have often been thwarted as such devices are ungainly for carrying on a motorcycle or other small vehicle and could be stolen by thieves or taken mischievously by adolescents.

Further, small vehicles are as prone or more prone to break down as other vehicles and pose a unique hazard to traffic in that they are difficult to see due to their relative size. In fact, most states require motorcycles to travel with their headlight lit day and night when in operation so as to aid other motorists in seeing such vehicles. Therefore, when such a vehicle is incapacitated, for example, when a motorcycle develops a flat tire or engine trouble, it may need to be left at the side of a road or highway so that the rider can go for help. In such instances the narrow profile of the motorcycle and the relatively small number of reflective surfaces (particularly at night) can obscure the vehicle and pose a hazard to other traffic, often travelling at speeds in excess of 50 miles per hour (as on highways). It may be too late, when traveling at highway speeds, to notice a motorcycle or other small vehicle at the side of the road, thereby causing a significant hazard to traffic. Particularly dangerous is the likelihood of another small vehicle, travelling near the edge of the highway, as is often the case to help it avoid dangerous drafts caused by larger passing vehicles, hitting a difficult to see motorcycle stationed at the side of the road for emergency reasons.

It would therefore be desirable to have a warning system and device wherein the device is easily viewable due to its positioning size and/or color; violates no motor vehicle regulations; is lightweight and portable and is easy to use. Further, a device of the present invention that is securely attachable to a motorcycle or other small vehicle that could be used to alert oncoming drivers to the presence of a motorcycle or other small vehicle in a parking space or on the road, would be advantageous. Such a device could be used as a daily warning in parking situations and can prove to be a significant aid to a small vehicle in a distress situation on a road or highway.

### SUMMARY OF THE INVENTION

In accordance with the present invention an alerting device for use with motorcycles and small vehicles, is provided. In a preferred embodiment, the alerting device comprises a portable warning fixture and, a means for securely connecting the warning fixture to a vehicle and for allowing the secure extension of the warning fixture to a desired distance from the vehicle such that the warning fixture can be placed so as to give notice of the presence of the vehicle. In one embodiment the portable warning fixture is a compactable warning cone and in another embodiment the portable warning fixture is a compactable flag; it will be understood by persons having ordinary skill in the art that the warning fixture can take any desirable shape without departing from the novel scope of the present invention.

In several embodiments of the present invention, the alerting device includes means to secure elements of the device to the vehicle, such that the warning device will not be lost or stolen during times when the owner of the vehicle is away from the vehicle. In one embodiment the means to secure the warning fixture is a line. It will be understood by persons having ordinary skill in the art that the “line” of the present embodiment can be made of any material having desired properties, such as cable, rope, string (made of numerous materials) and others that can provide the user with the ability to secure the device while extending the device to a desirable location to assist in its function, as will be described in greater detail below.

As will be understood, it is desirable to provide a housing for the device of the present invention. In one embodiment the housing contains a warning fixture, such as a cone or flag, as noted above, and also contains the line when the alerting device is not in use, that is the line is not extended in such a manner so as to secure the device of the present invention to a vehicle. The housing can be made in various shapes and sizes; however in a preferred embodiment, the housing is compact, so as to allow it to be easily stored on or within a small vehicle and further comprises elements that more easily permit the use of the device. Such elements as a pop-off lid, or in an alternative embodiment a hinged lid on the housing, to permit the warning device to emerge therefrom and one or more openings to allow the securing line to be housed therewithin and emerge neatly from when extended are part of the novel scope of the present invention. Such pop-off lids can provide the additional element of a kickstand support means, wherein the flat lid gives a good platform for placing the kickstand instead of placing it on the ground; in particular when asphalt pavements are hot, due to ambient conditions, kickstands have been known to penetrate the surface of the roadway. By using the lid as a stand support, the weight of the motorcycle is distributed over a larger area helping to prevent penetration. In other embodiments, the housing will either contain a weight or comprise a weight that will allow the device to maintain a low center of gravity such that elements of the ambient weather, including wind, are prevented from toppling the warning device while in use.

In the preferred embodiment, the alerting device includes a housing as described above, carried by the vehicle and securely tethered to the vehicle by the line. In one such embodiment, the housing is substantially compact to be attached to the license plate holder of a motorcycle, providing a convenient place to store the device, in an area typically not used for storage.

The weight in certain embodiments can be ring shaped, such that the circumference of the ring is the same or concentric with that of the warning fixture (a cone) so that the weight and fixture fit together well and offer a pleasant and well balanced arrangement. It will also be clear that by using circular shaped elements a spool or reel to hold the line, noted above, can be fit about or within the noted ring elements.

It will be further understood that the device of the present invention can be used to indicate the presence of a small vehicle, such as a motorcycle within a parking space it can also be utilized to help see a small vehicle on the side of a road during a road side emergency (such as a mechanical failure, a flat tire or even a medical emergency requiring the vehicle to be stopped). In one embodiment the invention can be used to assist the owner of the vehicle in finding a small vehicle in a large parking lot or other location.

Elements of various embodiments of the present invention can include a retractable spring loaded spool for retracting the warning fixture and line back to their respective storage positions, locking elements to secure the device of the present invention to the vehicle to secure it against theft or mischief; cloth or plastic warning fixtures; telescopic elements (provided as either a flag-like staff or in numbers to produce a skeletal structure) to aide in the compactability of the warning fixture within the housing. Various colors for fabrics and materials can be employed to provide the best alert for the vehicle in various situations and lights, continuously lit or variably flashing, or other illuminating means, such as luminescent fabrics and individual elements (charges with phosphors or radioactive elements) can be employed to provide warning in dim light or darkness.

The device of the present invention can then be used in a method of alerting passers-by by providing the device as described above, housed on or within a small vehicle; providing a securing means attached to the alerting device and the vehicle, for securely connecting the alerting device to the vehicle. Then allowing the device to be placed distally from the vehicle, for example by using a line to attach one to the other, such that the alerting device can be placed so as to give notice of the presence of the vehicle. The method would include stationing the vehicle, either in a parking space or when in an emergency, at the side of a road, and placing the alerting device at the desired distance from the vehicle so as to alert passers-by to the presence of the vehicle.

In preferred embodiments of the method of use of the present invention, a compactable warning fixture, such as a collapsible cone or flag is released from its housing to provide the appropriate warning. Further, a weight within the alerting device can be included so that when the warning fixture is unpacked the alerting device maintains a low center of gravity keeping it from tipping over during windy conditions.

In another embodiment retractable signaling apparatus and a method of using the apparatus to alert oncoming traffic to the presence of a vehicle otherwise obscured from view, such as being parked such that its presence is not detectable from the street, is provided. The apparatus comprises a retractable signaling device having a housing, for storage of a signal element. The housing further having at least one opening, a retraction system comprising a retraction mechanism attached to one end of a cord wherein the retraction mechanism is affixed to an inner wall of the housing and a signal element affixed to the housing such that it can lie inside the housing in a substantially flat position and be actuated into an extended position outside the housing. The housing in a preferred embodiment can be approximately 6 inches long, 6 inches wide and 1 inch high and have an opening in a top wall. The housing in one preferred embodiment can be made of a weather resistant rubber, or plastic, wood or metal. Additionally, the housing in the preferred embodiment contains a weighted ring with an approximately 5.5 inch outside diameter; the ring being attached at or about the center of the bottom inner wall of the housing.

In the present embodiment at least one telescopically extendable support is attached to the weighted ring. In embodiments where there are more than one telescopically extendable support, as contemplated by the present invention, such supports would be joined at their distal ends by a connecting ring, in a manner that would facilitate use and storage of the signal device.

In the present embodiment a brightly colored nylon cloth can be attached to the extendable supports such that when the supports are extended a signal element is formed and when the supports are collapsed all of the materials fit inside the housing and can be covered by a lid.

The present invention is directed to a signaling apparatus and a method of using the apparatus to alert oncoming traffic to the presence of a stationed vehicle that is obscured from view. The vehicle used in conjunction with this apparatus and method could be any of a wide variety of vehicles including but not limited to motorcycles, bicycles and small cars. Further the invention is useable with other objects that may otherwise be in harms way, such as large packages or stacks of materials and other items that may be in harms way were temporarily placed. However, as detailed below, the item used by way of example for the illustrative embodiment is a motorcycle. Persons having ordinary skill in the art will understand that any one of the above mentioned vehicles as well as other vehicle and items that might become obscured from view may be substituted therefore without departing from the novel scope of the present invention.

Further objects, features and advantages of the present invention will be apparent from the following description and the appended claims when taken in conjunction with the accompanying drawings.

### BRIEF DESCRIPTION OF THE DRAWINGS

FIG. 1 is a perspective view of a series of vehicles in a parking situation.

FIG. 2 is a perspective view of an embodiment of the present invention in an extended, ready to use, state.

FIG. 2a is a perspective view of the invention of FIG. 2 in a collapsed stored state.

FIG. 3 is a top view, partially cut away, of an embodiment of the present invention.

FIG. 4 is a cross sectional view of the invention taken along lines 4-4 of FIG. 2a.

FIG. 5 is a perspective of one embodiment of the present invention with a section enlarged to show detail.

FIG. 6 is an exploded view of an embodiment of a means to attach and use the device of the present inventions.

FIG. 7 is a side elevational view of an embodiment of the present invention.

FIG. 8 is a perspective view of a series of vehicles in a parking situation utilizing the device and method of the present invention.

FIG. 9 is a perspective view of a further embodiment of the device of the present invention.

### DETAILED DESCRIPTION OF THE ILLUSTRATIVE EMBODIMENTS

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Illustrative Embodiments”) relates to a requirement of the United States Patent Office, and should not be found to limit the subject matter disclosed herein.

In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

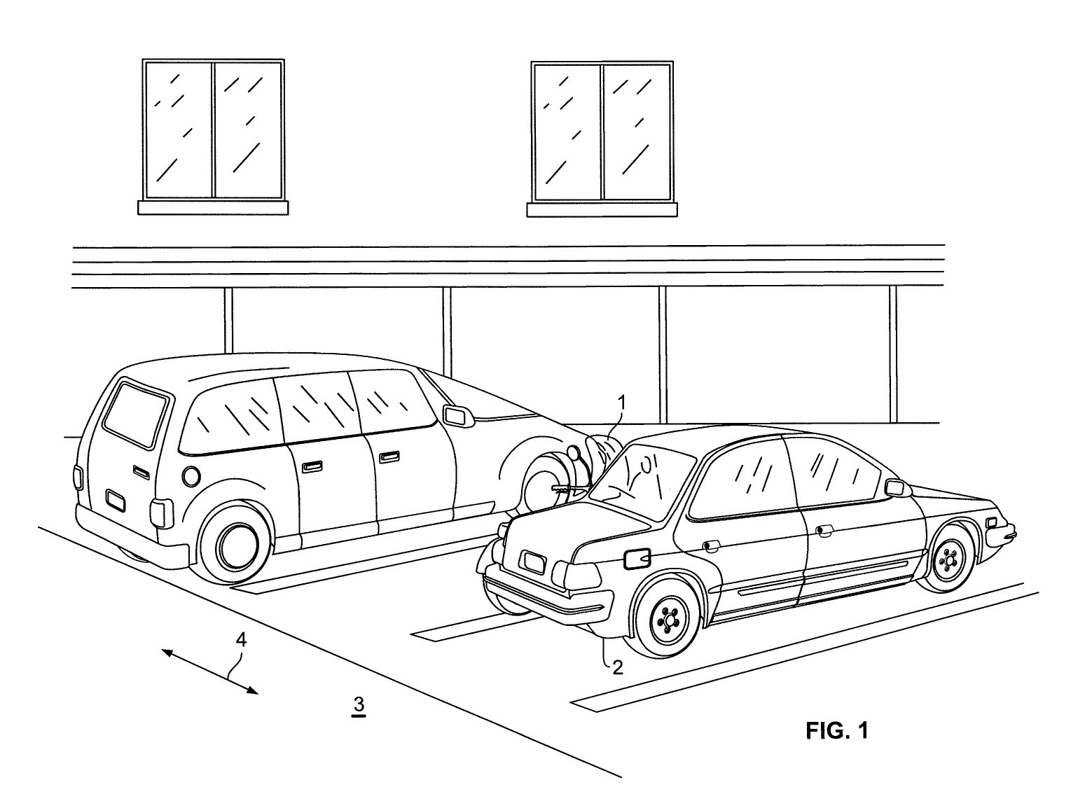

Referring now to FIG. 1, a perspective view of a parking situation, wherein a motorcycle 1 is seen to be parked between two automobiles 2 in a head-in style parking space along a roadway 3. From this perspective view it is clear that the motorcycle 1 is greatly obscured, from both sides, by the presence of the automobiles 2. While somewhat visible from the angle shown, it will be understood by persons having ordinary skill in the art that the visibility of the motorcycle 1 from the direction of traffic 4, due to the manner in which FIG. 1 is drawn (allowing the viewer to see that the motorcycle 1 is parked therein), would be less. Such a situation would possibly cause a person looking for a parking space to believe that the space between the other shown vehicles 2 is unoccupied. FIG. 1 is therefore illustrative of one of the dangers that the present invention alleviates.

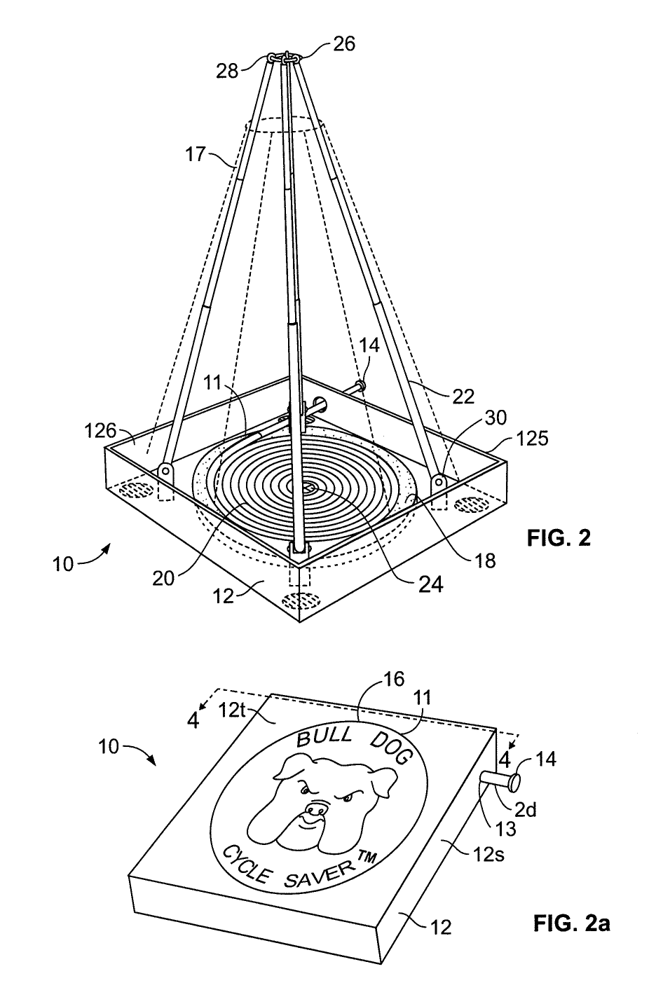

Referring now to FIGS. 2 and 2a, perspective views of one embodiment of the present invention in both an alert and storage state are shown. FIG. 2a shows the signaling apparatus 10 in a fully retracted, non-extended state while FIG. 2 shows the apparatus in an alert state. Substantively, the apparatus 10 comprises a housing 12, having side walls and a top and bottom, which is a protective cover and stand for a signaling means 17 and a security line 20; these and other elements will be described in greater detail below.

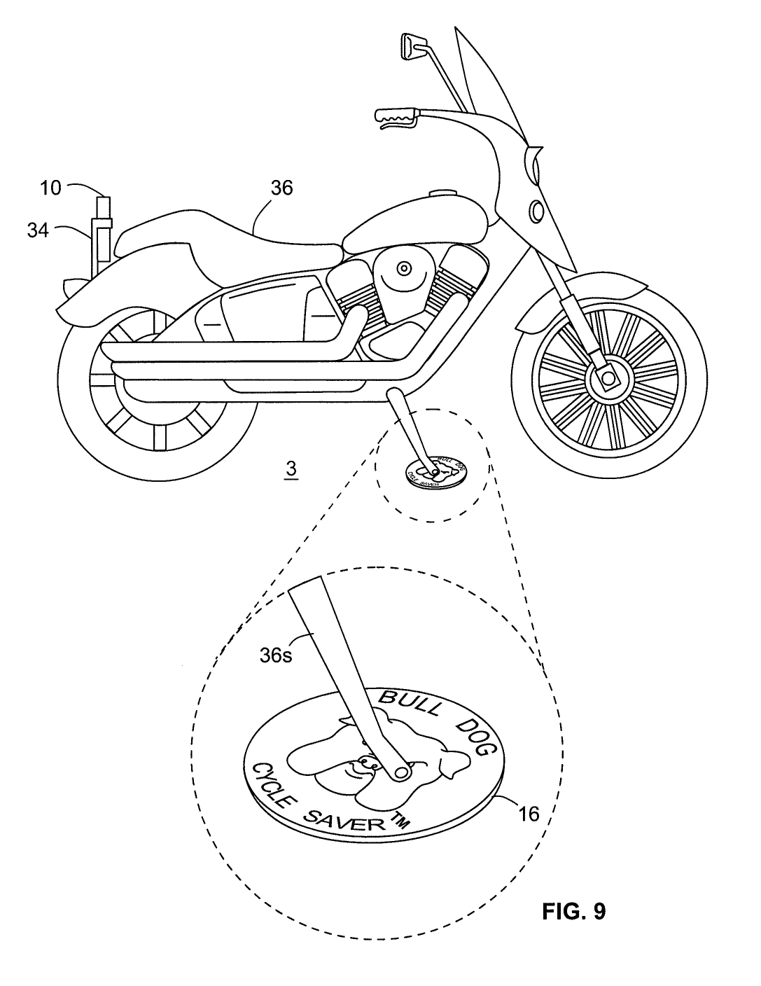

Housing 12 further comprises two main openings: a first large opening 11 (FIG. 2) in the top wall 12t of housing 12 and a second small opening 13 in a sidewall 12s. It will be seen that in a preferred embodiment, opening 13 is made at one end of sidewall 12s of the housing 12 so as to facilitate the unreeling and gathering of line 20, as will be discussed in detail below. As shown, large opening 11 can be covered by a lid 16, made of any suitable material, when apparatus 10 is not in use. A further use of lid 16 is discussed below and in association with FIG. 9. It will be understood that embodiments of the present invention can be made without a lid; in such situations signaling means 17 when in a collapsed stage comprises a covering for opening 11. Small opening 13 allows the user of the present invention to have access to a security line 20, contained within housing 12. An attachment loop 14 protrudes from housing 12, through small opening 13 so that apparatus 10 can be secured to a motorcycle 1 as will be explained in detail below. It will be understood that other means of attachment of the apparatus 10 to a vehicle or other object, such as locks of the type used to secure computers to desktops, and other locking or securing means can be used without departing from the novel scope of the present invention.

In one preferred embodiment, the housing 12 is about 6 inches long, about 6 inches wide and about 1 inch thick; however persons having ordinary skill in the art will understand that the housing can be any useful shape and/or size without departing from the novel scope of the present invention. Additionally, housing 12, in a preferred embodiment, is made of hardened rubber but can be made of any suitable material or combinations of materials, such as metal, wood or plastic and others, having similar or useful properties that are known to persons having ordinary skill in the art, without departing from the novel scope of the present invention.

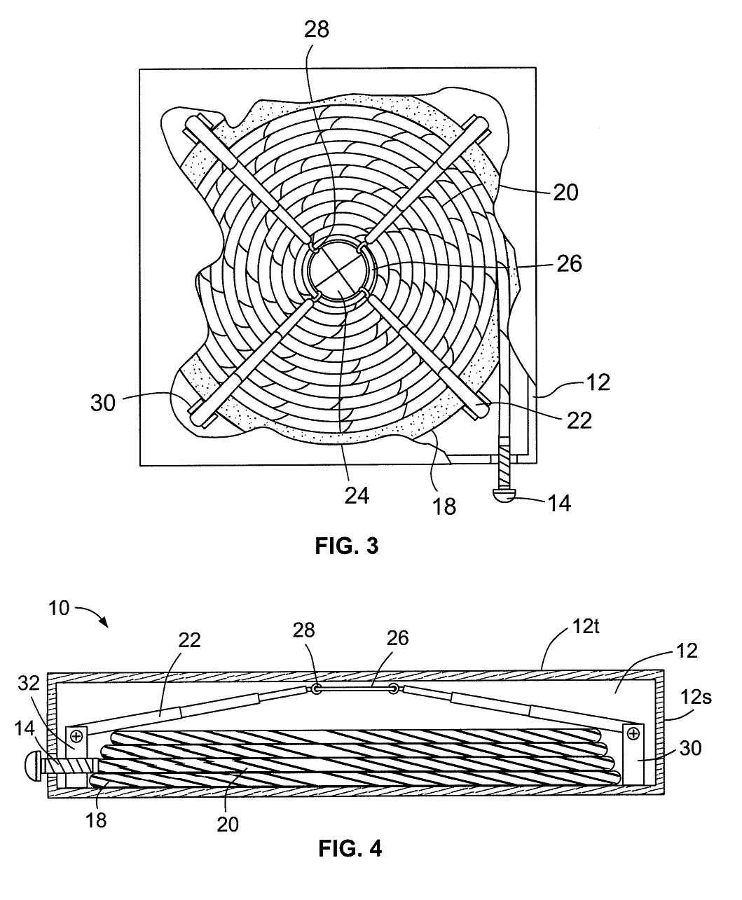

FIGS. 2-4 illustrate the inside of an embodiment of apparatus 10 in respectively both alert and storage states. Referring to these figures, it can be seen that within housing 12 a weight 18 rests within the inside of side walls 12s as does one or more supports 22. Weight 18 is provided to lower the center of gravity of apparatus 10 when in an alert state and thereby prevent apparatus 10 from blowing over or tipping over due to ambient environmental conditions, specifically wind, and to give apparatus 10 better overall stability. As shown, in one embodiment weight 18 is in the shape of a ring. In a specific embodiment weight 18 has an outside ring diameter of approximately 5.5 inches, which permits it to fit snugly within the housing noted above having an outer dimension of about 6 inches square. However, persons having ordinary skill in the art will understand that a weight or a number of weighted objects having various shapes or sizes or mass can be used for the stated function without departing from the novel scope of the present invention. As will be discussed in detail below, supports 22 can be of a flexible, collapsible or retractable type as required by the particular application.

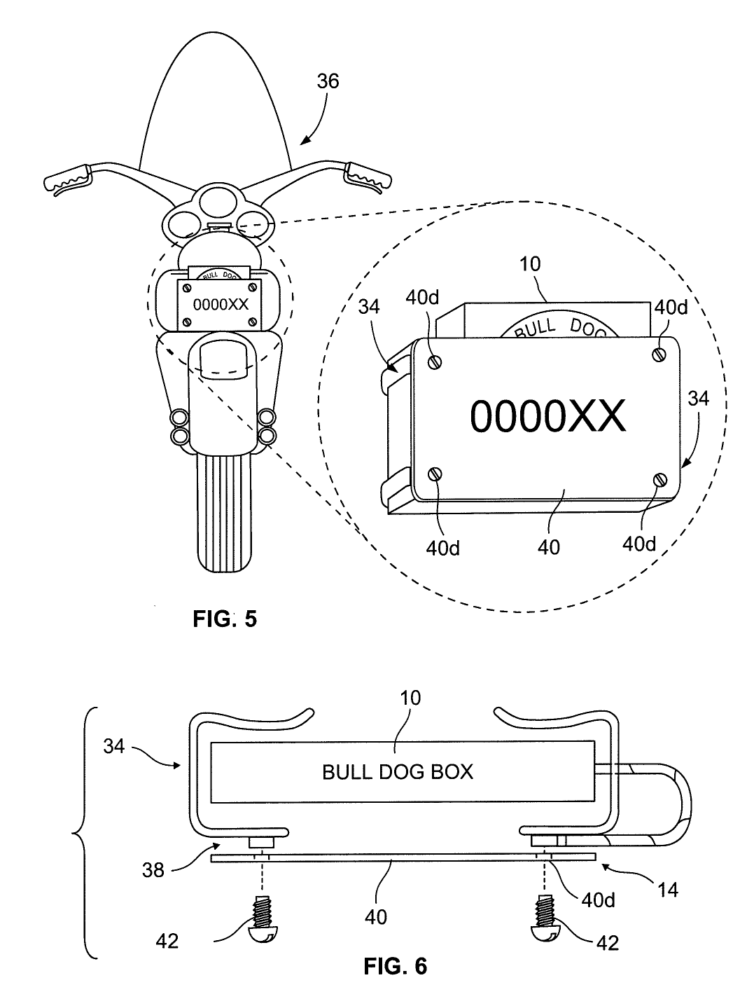

In the illustrative embodiment, a line 20 and line retraction mechanism 24 are also contained within housing 12 of apparatus 10. Line 20 can be of any flexible and strong material that permits the securing of the apparatus 10 to a vehicle, such as a cable, a rope, a string or other similar material, that is known to persons having ordinary skill in the art. Retraction mechanism 24, which is of a type well known in the art and can include either motorized or a spring mechanism that permits the line 20 to be extracted and then retracted within housing 12 or can be a simple spool onto which the line can be manually rewound, is attached to housing 12. Line 20 is attached within retraction mechanism 24 and wound in a manner that permits its easy extraction and retraction as desired by the user. In the present embodiment retraction mechanism 24 permits line 20 to extend out from the interior of housing 12 through the small opening 13 when housing 12 of apparatus 10 is pulled away from the attached motorcycle 36 (see FIG. 5).

In the use of the device of the present invention, line 20 is secured to a vehicle, in a manner to disclose below, and the housing 12 is extended to a desirable point where the device of the present invention will be most effective in alerting passers-by to the presence of the vehicle. When housing 12 is pulled distally from the motorcycle 36 line 20 is unreeled out of housing 12; line 20 then remains in an extended position until its retraction is desired by the user. The user then will make whatever action necessary to cause the retraction of line 20; for example in a motorized version a switch reversing the rotation of the retraction mechanism 24 would be activated, in a spring charged version, a yank of line 20 can cause the retraction of line 20, other such methods will be known to persons having ordinary skill in the art. The preferred method however is the pull and yank version as this requires the lightest weight equipment in the design.

As noted above, line 20 may be made of any suitable material for connecting the apparatus 10 with the motorcycle 36 as understood by a person having ordinary skill in the art. Line 20 is attached, in a preferred embodiment, to the retraction mechanism 24 at one end and to an attachment loop 14 at its distal end. In the illustrative embodiment, line 20 is coiled within housing 12 functionally about retraction mechanism 24 when apparatus 10 is in a storage state. However, the line 20 can be stored in any manner, known to persons having ordinary skill in the art, which does not disrupt its extension or retraction or the extension of the collapsible supports 22, without departing from the novel scope of the present invention.

Supports 22, in the illustrative embodiment, are telescopically extendable and collapsible members, having proximal ends 22p and distal ends 22d, that are attached at their proximal ends 22p by a hinge member 30 to a support member 32, which in turn is attached to an inner wall 12i of the housing 12. The hinge member 30 permits the rotation of support 22 about an axis perpendicular to the sidewalls of housing 12. In the illustrative embodiment, supports 22, hinge members 30 and support members 32 are made of metal and particularly of steel, however persons having ordinary skill in the art will understand that other materials, particularly those having similar structural characteristics as metal, may be substituted therefore without departing from the novel scope of the present invention. The supports 22 are attached at their distal ends 22d to a connecting ring 26 via eyelets 28 so that the supports 22 can rotate with respect to the connecting ring 26. When extended, supports 22, in the illustrative embodiment shown as collapsible members, form a conical shape. Housing 12 serves as the base of the cone formed by supports 22 and the connecting ring 26 serves as the cone's tip. Connecting ring 26 also allows the user to conveniently actuate the apparatus 10 from its non-extended state to its extended state and vice versa by pulling thereupon.

Referring now to FIG. 7, a cloth 44 is attached to supports 22, connecting ring 26 and housing 12 such that a solid cone 46 is formed when the apparatus 10 is in its extended position and that the cloth 44 and supports 22 lie substantially flat inside of the housing 12 when the apparatus is in its storage position. In the illustrative embodiment, cloth 44 is a brightly colored nylon material attached to supports 22 such that supports 22 are outside of cloth 44. However, a person of ordinary skill in the art will understand that various materials and types of material of various colors, including materials other than cloth, can be substituted, and that the material may also be attached to the outside of the supports 22, without departing from the novel scope of the preset invention.

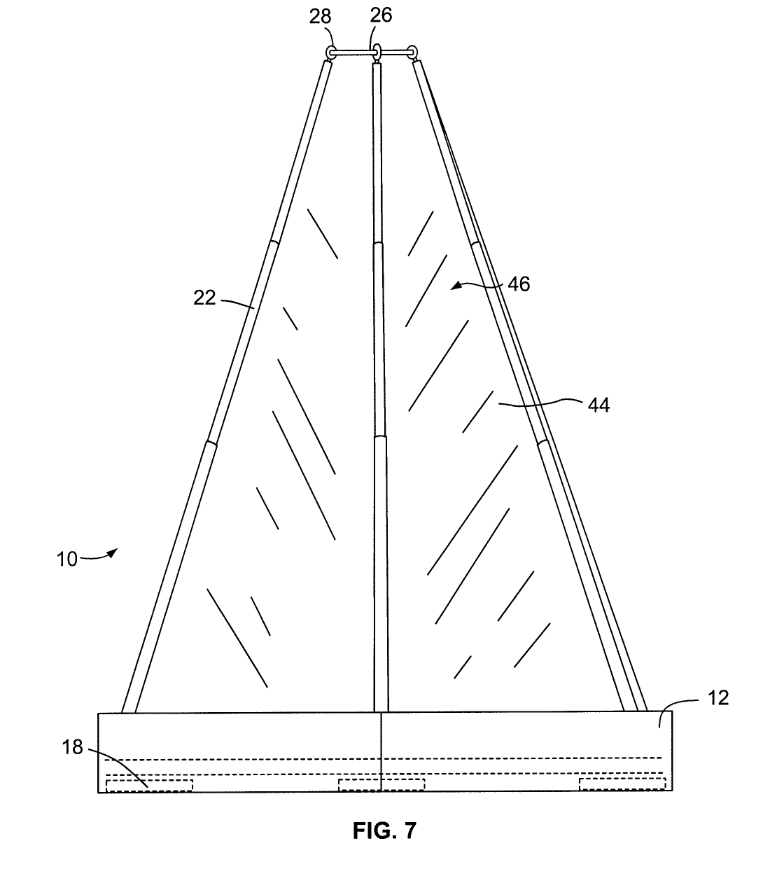

FIG. 5 and FIG. 6 are illustrative of how apparatus 10 can be attached to a motorcycle 36. It will be seen that attachment is made, in the illustrative embodiment, by using mounting brackets 34 which define a mounting opening 38 formed therein. In the illustrative embodiment, mounting brackets 34 are made of plastic and are formed in the shape of the letter C. In the illustrative embodiment two mounting brackets 34 are utilized to form a cradle by attachment, via mounting opening 38, using a fastener 42, such as a screw, to a surface on the item to be protected by the present invention. When apparatus 10 is inserted into the cradle formed by mounting brackets 34, apparatus 10 is held in place via tension formed by the bracket 34 resulting from its shape and its materials. Persons having ordinary skill in the art will understand that other types of mounting brackets can be used without departing from the novel scope of the present invention. Mounting brackets 34 are, in the illustrative embodiment, attached to the motorcycle's license plate 40, via the license plate mounting opening 0d, with mounting screws 42. Attachment loop 14, attached to line 20, is placed, in the illustrative embodiment, between one of the mounting brackets 34 and through the license plate mounting opening 40 such that the mounting screw will pass through the bracket, he attachment loop and license plate mounting opening securing apparatus 10 to motorcycle 36. Apparatus 10 can then be placed into the cradle formed by mounting brackets 34, behind the license plate 40, for convenient storage. Persons having ordinary skill in the art will appreciate that many other methods of attaching the apparatus 10 to a motorcycle 36, or other object to be protected, can be utilized without departing from the novel scope of the present invention.

In FIG. 9, a motorcycle 36 having a kick-stand 36s is shown utilizing the pop-off type lid 16 of one embodiment of the present invention as a kick-stand support stand. Riders of motorcycles, and others having skill in the art, will recognize that roadways, and in particular asphalt covered roadways, tend to get warm, and concomitantly soft, in conditions of bright sun shine and higher ambient temperatures. Warm asphalt tends to become somewhat pliable such that the weight of a motorcycle leaning on a kick-stand can tend to push the stand into the road surface. Consider that a motorcycle can weigh several hundred pounds and that the typical kick-stand can have a tip surface area (that is the area of contact with the roadway) of about one square inch. As such, the pressure at the kick-stand placed onto the road can exceed several hundred pounds per square inch, providing ample opportunity for the kick-stand to penetrate the roadway surface 3. The use of the lid 16 disperses the load of the weight of the vehicle 36 as transmitted through the kick-stand 36s over the surface area of the lid. For example, using a lid of an embodiment noted above having a top having dimensions of about 6 inches wide by 6 inches long provides a surface area of about 36 square inches. A vehicle weighing 500 pounds could transfer weight at the rate of about 500 pounds per square inch leaning on its kick-stand having a one-square inch tip surface area; and in sharp contrast, about 14 pounds per square inch when placed on the device lid 16.

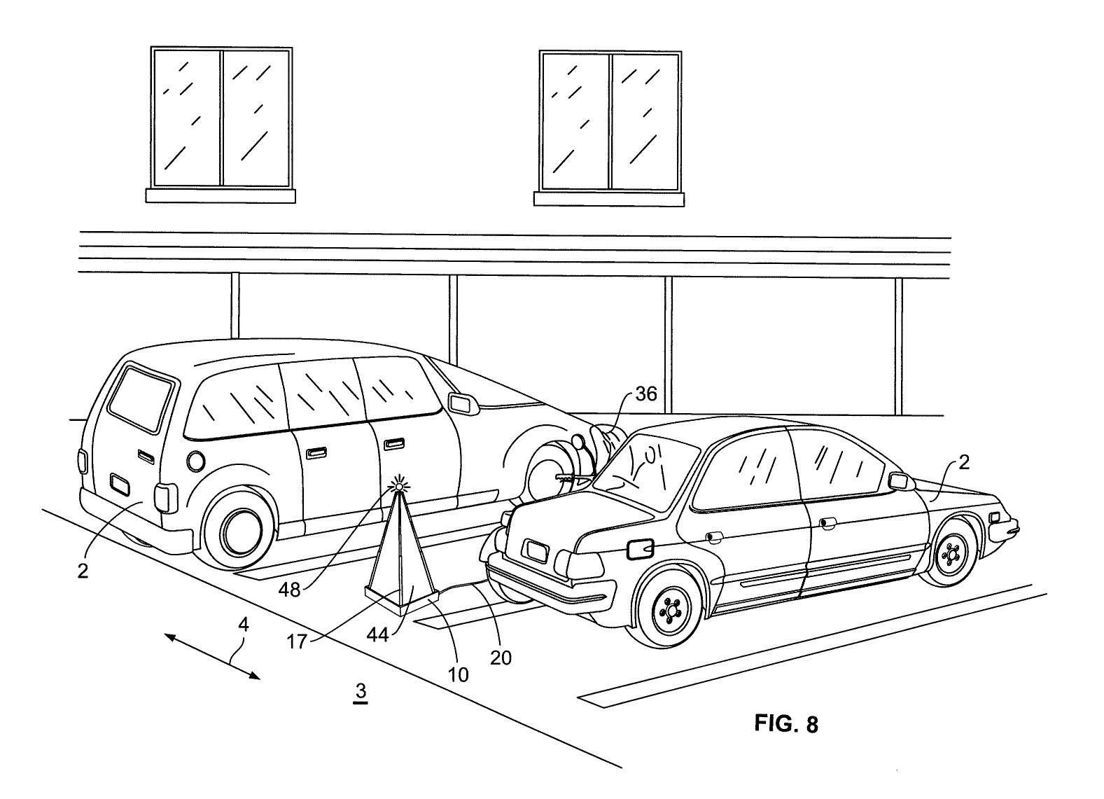

In the use of device of the illustrative embodiment of the claimed invention a device as describe above is provided and attached in the manner noted. When, a motorcycle 36 is parked in a parking space, or stationed at the side of the road, where it may be obscured from the normal view of a passer-by, the user removes housing 12 from the mounting brackets 34. The housing 12 is extended away from the motorcycle 36 to a desirable position, such as to the back of the parking space. The user then causes retraction mechanism 24 to lock in place thereby keeping line 20 in its extended position. Then, referring to FIG. 8, the user places the housing 12 on the ground or paved surface 3, removes the lid 16 if present and pulls up on the connecting ring 26 thereby causing supports 22 and brightly colored material 44 to extend from housing 12 to form a cone to warn oncoming traffic of the presence of the parked or stationed vehicle 36. In FIG. 8 signaling apparatus includes an optional lighted member 48, which can be an LED or other small power light source which can be powered by a battery, not shown. The use of an LED, particularly in a night-time situation can aid in seeing the signaling device and concomitantly, the vehicle. It will be understood that other means of allowing the device to be viewed in dim or low light, such as luminescent materials and indirect lighting means, can be employed in a device of the present invention without departing from its novel scope; further a more simple device, having no illumination, is also contemplated.

In one embodiment the device of the present invention can include a siren or other noise generation device, such as a horn, beeper, buzzer, automotive panic type sound generator or others known to persons having skill in the art and a means to remotely activate the device. In a preferred embodiment, the noise generator would be located within the base of the device and could serve to offset part of the weight 18 (FIG. 2) used as ballast. The noise generating device would be connected to a receiver, of the type generally used in automobile remote access devices, which would be triggered by a remote control carried by the user. As the user approaches the vehicle he could remotely activate the noise generating device so as to more easily locate the vehicle through the device of the present invention. In a further embodiment, the noise generating device and remote receiver can also be connected to lighted member 48, so that both an audible and visible signal can be generated in response to a remote control inquiry as to location. Concomitantly, when the device is stored on a motorcycle or other small vehicle, the user can activate the noise making device, in a panic situation, to provide a loud alarm to frighten persons away or to assist in securing help from the police or passers-by. In an additional embodiment, the receiver within the base of the device can be a proximity sensor such that when a vehicle or person enters a zone proximal to the vehicle being protected, the receiver causes the noise making device to generate noise and can, in a further embodiment, cause the lighted member 48 to activate to aid in warning of the stationary vehicle's presence.

The specific embodiments of the present invention have been described for the purpose of illustrating a manner in which the invention is made or used. It should be understood that the implementation of other variations and modifications of the invention and its various aspects will be apparent to a person having ordinary skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

What is claimed is:

1. An alerting device for use with motorcycles and small vehicles, comprising:
a portable warning fixture; and,
a means for securely connecting the warning fixture to a vehicle and for allowing the secure extension of the warning fixture to a desired distance from the vehicle such that the warning fixture can be placed so as to give notice of the presence of the vehicle.

2. The alerting device of claim 1 wherein the portable warning fixture is a compactable warning cone.

3. The alerting device of claim 1 wherein the portable warning fixture is a compactable flag.

4. The alerting device of claim 1 wherein the means for securely connecting the warning fixture is a line.

5. The alerting device of claim 4 wherein the line comprises a cable.

6. The alerting device of claim 4 wherein the line comprises a rope.

7. The alerting device of claim 1 including a housing, carried by the vehicle, for containing the warning fixture and the line when the alerting device is not in use.

8. The alerting device of claim 1 including a housing carried by the vehicle and securely tethered thereto by the line such that the warning fixture and the line are contained therewithin when not in use and such that the housing comprises a base for the warning fixture when the alerting device is in use.

9. The alerting device of claim 1 including a housing and housing lid carried by the vehicle, the housing lid providing a base for a motorcycle kick-stand when the alerting device is in use in association with a motorcycle.

10. The alerting device of claim 8 wherein the housing is weighted so as to maintain the warning fixture in a desired alerting position during adverse ambient conditions.

11. The alerting device of claim 10 wherein the housing is weighted by at least one weight shaped as a ring.

12. An alerting device for use with motorcycles and small vehicles, comprising:
a portable warning fixture comprising a compactable indicator;
a line for securely connecting the alerting device to a vehicle and for allowing the secure extension of the warning fixture to a desired distance from the vehicle such that the warning fixture can be placed so as to give notice of the presence of the vehicle; and
a housing, carried by the vehicle, for containing the warning fixture and the line when the alerting device is not in use.

13. The alerting device of claim 12 wherein the housing is secured to the vehicle such that the warning fixture and line can be securely stored when not in use.

14. The alerting device of claim 12 wherein the housing is secured to the vehicle and the line is secured to the housing such that the warning fixture and line cannot be taken from the vicinity of the vehicle.

15. The alerting device of claim 12 wherein the housing comprises a weight positioned to keep the indicator erect when in use.

16. The alerting device of claim 15 wherein the indicator is comprised of a cloth affixed to at least one support.

17. The alerting device of claim 16 wherein the cloth is affixed to four supports.

18. The alerting device of claim 17 wherein the supports each have a first end and a second end is affixed at a first end to the housing weight.

19. The alerting device of claim 17 wherein each support comprises a telescopic mast that can be extended in use and collapsed for storage.

20. The alerting device of claim 18 wherein the supports are all affixed together at the second end of each support to a connecting ring.

21. A method of alerting passers-by to the presence of a stationary vehicle comprising:
providing a portable alerting device;
providing a securing means, attached to the alerting device and a vehicle, for securely connecting the alerting device to the vehicle and for allowing the secure extension of the alerting device to a desired distance from the vehicle such that the alerting device can be placed so as to give notice of the presence of the vehicle
stationing the vehicle and placing the alerting device, secured by the securing means, at the desired distance from the vehicle so as to alert passers-by to the presence of the vehicle.

22. The method of alerting passers-by of claim 21 including the step of providing a compactable warning fixture within the alerting device such that the alerting device can be made compact for storage and the warning fixture can be unpacked from the alerting device to provide a visual alert.

23. The method of alerting passers-by of claim 22 including the step of providing a weight within the alerting device so that when the warning fixture is unpacked the alerting device maintains a low center of gravity.

24. The method of alerting passers-by of claim 22 including the step of providing a length of line to the securing means such that the alerting device can be extended about the length of the line radially from the vehicle.

25. The method of alerting passers-by of claim 22 including the step of providing a noise generating device and signal receiving device within the portable alerting device and a remote control for activation of the receiving device, such that when the remote control is activated, the noise generating device is activated to warn of the presence of the vehicle.
